(19) United States
(12) Patent Application Publication
(10) Pub. No.: US 2011/0189897 A1
(43) Pub. Date: Aug. 4, 2011

(54) CARD CONNECTOR HAVING INSERT MOLDED TERMINALS

(75) Inventors: JIAN-FEI YU, Kunshan (CN); QI-JUN ZHAO, Kunshan (CN)

(73) Assignee: HON HAI PRECISION INDUSTRY CO., LTD., New Taipei (TW)

(21) Appl. No.: 13/015,259

(22) Filed: Jan. 27, 2011

(30) Foreign Application Priority Data
Feb. 4, 2010 (CN) 201020302338.X

(51) Int. Cl. H01R 24/76

(52) U.S. Cl. 439/630

(57) ABSTRACT

A card connector includes an insulative housing (1), a set of terminals (2) insert molded into the insulative housing and a metal shell (5) attached to and covering the insulative housing. The insulative housing has a receiving space (11) and a bottom wall (12) located under the receiving space. The bottom wall has a recess (126) recessed downwardly from an upper face (18) thereof and located in a front region thereof, and a recessed wall (121) located under the recess and defining an upper face located lower than the upper face of the bottom wall. The terminals includes retaining portions (21) retained in the recessed wall, contacting portions (22) protruding upwardly into the receiving space, and tail portions (23) extending outwardly of the insulative housing for being mounted onto a printed circuit board. The retaining portions (21) have upper faces exposed to the recess (126) and coplanar with the upper face of the recessed wall (121).

### BACKGROUND OF THE INVENTION

1. Field of the Invention

The present invention relates to a card connector, and more particularly to a card connector having terminals insert molded into an insulative housing.

2. Description of Related Art

With constant development of communications and computer technology, more and more electrical cards are being designed to meet various requirements. Electrical card connectors are used to connect these electrical cards with corresponding mainframes. A conventional card connector usually comprises an insulative housing, a plurality of terminals attached thereto, an ejecting mechanism retained in the insulative housing for ejecting the electrical card out of the insulative housing and a shell shielding the insulative housing. The insulative housing has a receiving space for insertion of a memory card and a bottom wall located under the receiving space. The terminals have retaining portions retained in the bottom wall, contacting portions protruding upwardly into the receiving space from the retaining portions for mating with the memory card, and tail portions extending outwardly of the insulative housing for being mounted onto a printed circuit board.

The retaining portions of the terminals could be assembled to the bottom wall or insert molded into the bottom wall so as to be retained in the bottom wall firmly. When the retaining portions are located at front of the contacting portions, top faces of the retaining portions are usually covered by the bottom wall so that the retaining portions can not scratch a lower face of the memory card or a label formed on the lower face of the memory card. However, the bottom wall has to be molded with mass plastic materials which will increase the manufacturing cost, and an upper face of the bottom wall will scratch the lower face of the memory card or the label formed on the lower face of the memory card inevitably.

Hence, an improved card connector is desired to overcome the above problems.

### BRIEF SUMMARY OF THE INVENTION

According to one aspect of the present invention, a card connector for insertion of a memory card comprises an insulative housing defining a receiving space for insertion of the memory card and a bottom wall located under the receiving space, the bottom wall having a recess recessed downwardly from an upper face thereof and located in a front region thereof, and a recessed wall located under the recess and defining an upper face located lower than the upper face of the bottom wall; a plurality of terminals insert molded into the insulative housing and comprising retaining portions retained in the recessed wall, contacting portions protruding upwardly into the receiving space from the retaining portions for mating with the memory card, and tail portions extending outwardly of the insulative housing for being mounted onto a printed circuit board, the retaining portions having upper faces exposed to the recess and coplanar with the upper face of the recessed wall; and a metal shell attached to and covering the insulative housing.

According to another aspect of the present invention, a card connector for insertion of a memory card comprises an insulative housing defining a receiving space for insertion of the memory card and a bottom wall located under the receiving space; and a plurality of terminals insert molded into the insulative housing and comprising retaining portions retained in the bottom wall and having upper faces exposed out, contacting portions protruding upwardly into the receiving space from the retaining portions for mating with the memory card, and tail portions extending outwardly of the insulative housing for being mounted onto a printed circuit board. Wherein the terminals further comprise embedded portions extending forwardly from front ends of the corresponding retaining portions and wholly embedded in the bottom wall.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of a card connector according to the present invention;

FIG. 2 is a partly exploded view of the card connector shown in FIG. 1;

FIG. 3 is an exploded view of the card connector shown in FIG. 1;

FIG. 4 is a front elevation view of the card connector shown in FIG. 1;

FIG. 5 is a cross sectional view of the card connector taken along line 5-5 shown in FIG. 1;

FIG. 6 is an partly enlarged view of a circle portion of the card connector shown in FIG. 1;

FIG. 7 is a perspective view of a memory card for being inserted into the card connector shown in FIG. 1;

FIG. 8 is similar to FIG. 7, but viewed from another aspect; and

FIG. 9 is a front elevation view of the memory card shown in FIG. 8.

### DETAILED DESCRIPTION OF THE PREFERRED EMBODIMENT

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

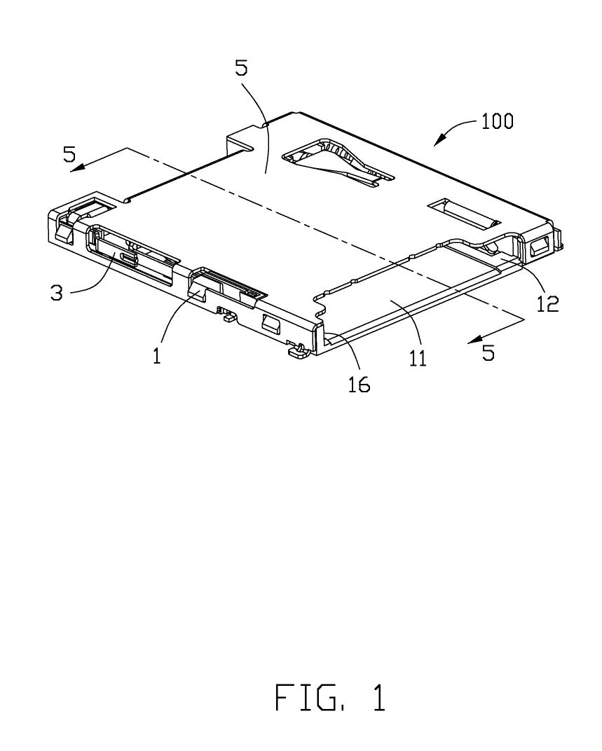

Referring to FIGS. 1-3, a card connector 100 for receiving a memory card 9 according to the present invention, comprises an insulative housing 1, a plurality of terminals 2 retained in the insulative housing 1, an ejecting mechanism 4 coupled to the insulative housing 1, a pair of switch contacts 3 retained in the insulative housing 1, and a metal shell 5 covering the insulative housing 1. In the preferred embodiment, the memory card connector 100 is a Micro SD card connector; and the memory card 9 is a Micro SD card 9.

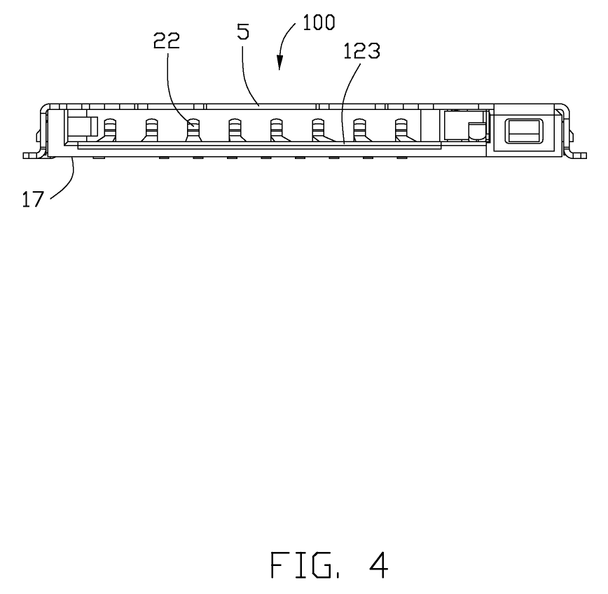

Referring to FIGS. 1-4, the insulative housing 1 is molded of dielectric materials such as plastic or the like and defines a receiving space 11 for receiving the memory card 9. The insulative housing 1 comprises a bottom wall 12 located under the receiving space 11, a rear wall 15 extending upwardly from a rear end of the bottom wall 12, and a pair of left and right walls 13, 14 extending upwardly from two lateral sides of the bottom wall 12 and connecting with the rear wall 15. The insulative housing 1 defines a reception opening 16 at front of the receiving space 11 for insertion of the memory card 9.

The bottom wall 12 has a recess 126 recessed downwardly from an upper surface 18 thereof and communicating with the receiving space 11, a recessed wall 121 located under the recess 126, a slot 123 passing through the upper surface 18 and a bottom surface 17 thereof and located behind the recess 126, and a beam portion 122 formed between the recess 126 and the slot 123. The recessed wall 121 defines a plurality of cavities 121b formed therein, a plurality of pairs of protrusions 121c formed between each two adjacent cavities 121b, and a plurality of circle holes 121a formed between each pair of protrusions 121c and located between each two adjacent cavities 121b. The left wall 13 has first and second grooves 131, 132 formed therein for receiving the switch contacts 3. The right wall 14 has a heart-shaped cam groove 142 formed on a rear side thereof, a sliding groove 141 formed at a side of the heart-shaped cam groove 142, and a post 143 protruding forwardly into the sliding groove 141.

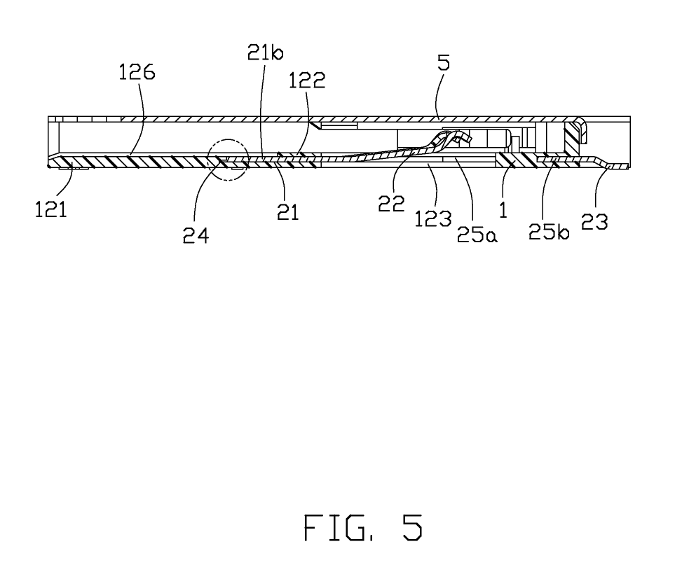

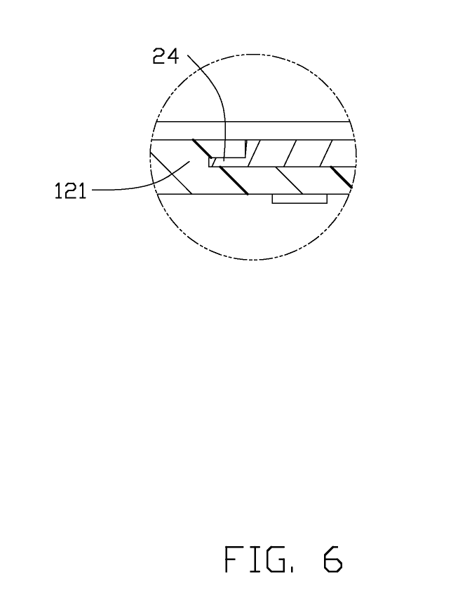

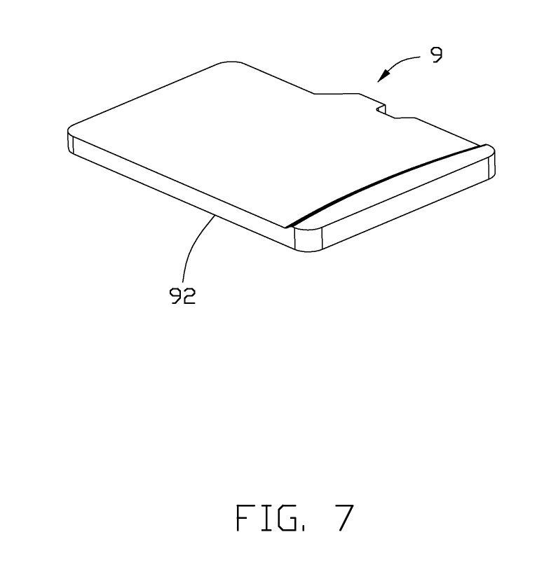

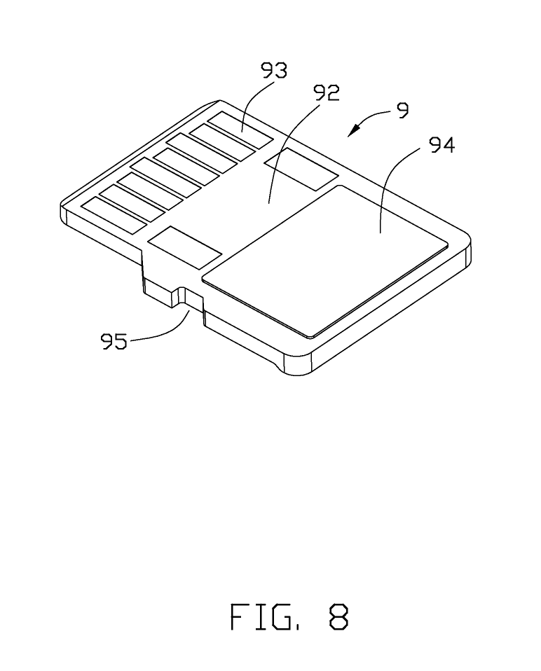

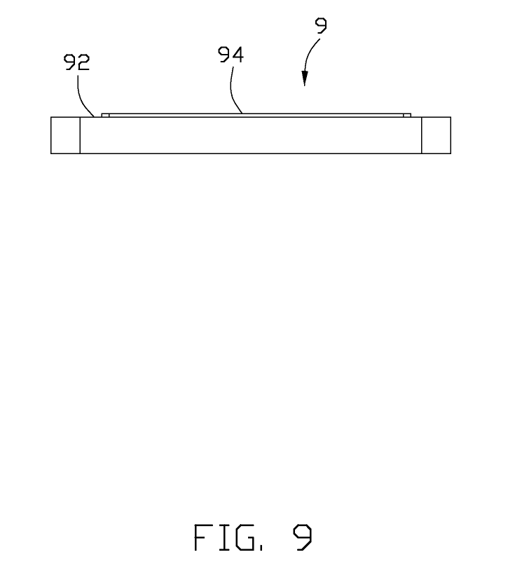

Referring to FIGS. 1-9. The terminals 2 are integrally molded with the bottom wall 12. Each terminal 2 has a retaining portion 21, a tail portion 23 extending backwardly beyond the rear wall 15 for being mounted onto a printed circuit board (not shown), a connecting portion 25 connecting the tail portion 23 and the retaining portion 21, a contacting portion 22 extending backwardly from the retaining portion 21 and protruding upwardly into the receiving space 11 for electrically and mechanically mating with a corresponding metal pad 93 of the memory card 9, and an embedded portion 24 extending forwardly from the retaining portion 21 and having a thickness in a height direction thinner than that of the retaining portion 21. The retaining portion 21 has a front part 21b received in the corresponding cavity 121b and defining an upper face exposed to the recess 126, and a rear part 21c embedded in the beam portion 122. The embedded portion 24 has a lower face coplanar with a lower face of the retaining portion 21 and an upper face lower than the upper face of the retaining portion 21. The embedded portion 24 is wholly embedded in the recessed wall 121, and the upper face of the retaining portion 21 is coplanar with an upper face of the recessed wall 121. When the memory card 9 is being inserted into or extracted out of the card connector 1, a label 94 positioned on a lower face 92 of the memory card 9 will not touch with the upper face of the recessed wall 121, and the front part 21b of the retaining portion 21 can not scratch the label 94. Furthermore, a front end of the front part 2 lb can not warp up to scratch the label 94 as the embedded portion 24 which connects the retaining portion 21 is wholly embedded in the recessed wall 121. The connecting portion 25 has a first part 25a extending backwardly from the rear part 21c of the retaining portion 21 and received in the slot 123, and a second part 25b extending backwardly from the first part 25a and embedded in the bottom wall 12. The terminals 2 are stamped out from a piece of sheet metal material and connected by two contact carriers (not shown) at the front parts 21b of the retaining portions 21 and the first parts 25a of the connecting portions 25, after the terminals 2 are insert molded into the insulative housing 1, the contact carriers are cut off from the circle holes 121a and a set of cutting holes 125 formed on the bottom wall 12, then the terminals 2 are separated from each other so as to transmit signals independently.

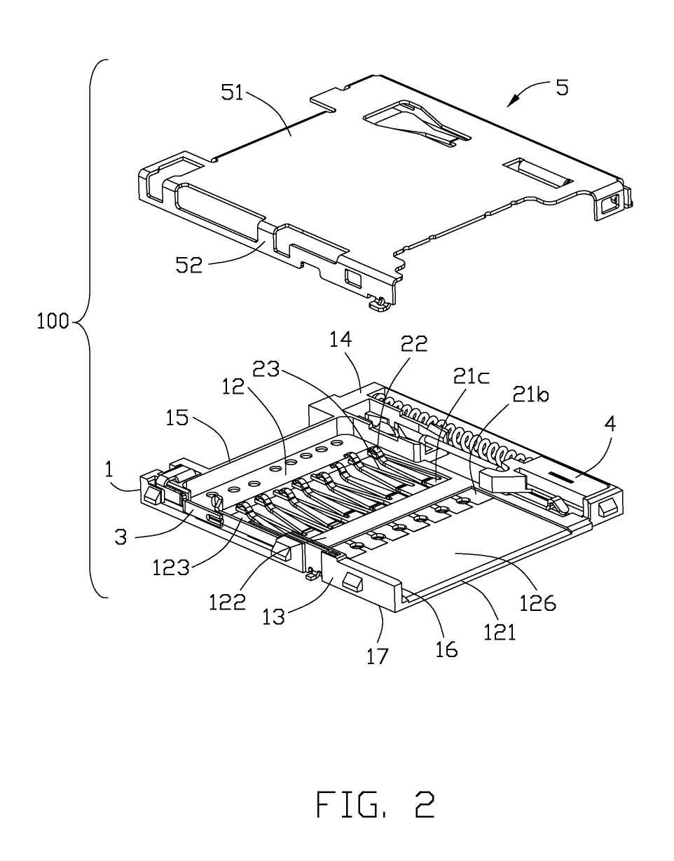

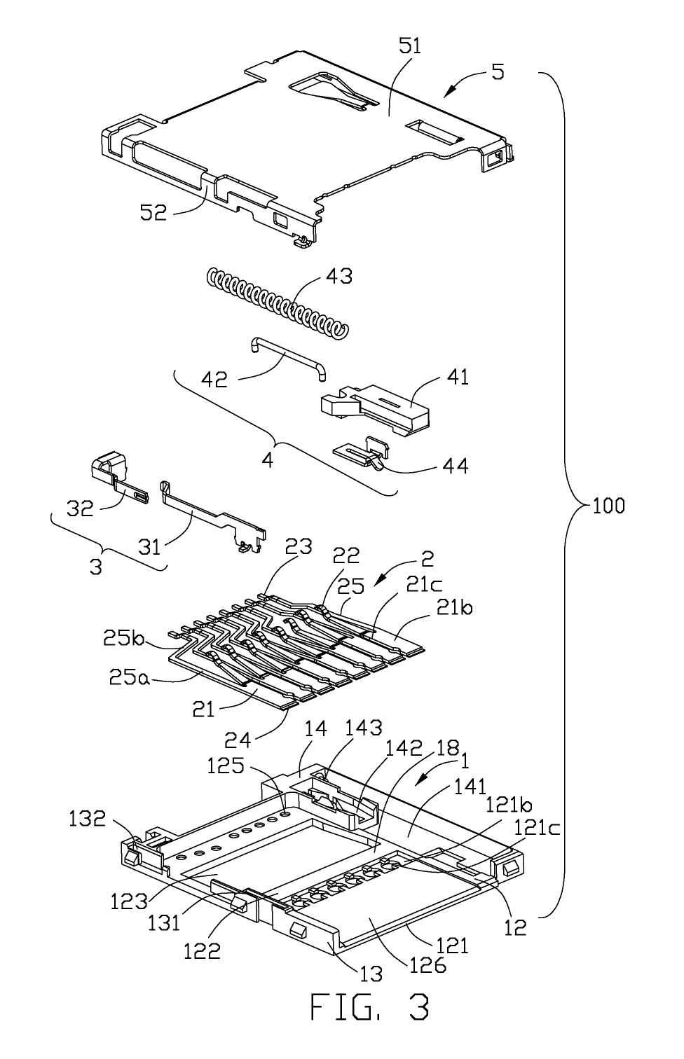

Referring to FIGS. 2 and 3, the ejecting mechanism 4 is located on a right side of the bottom wall 12 and comprises a slider 41 movable along card-insertion or card-withdrawing directions, a connecting rod 42 for restraining the slider 41, a coil spring 43 for urging the slider 41, and a spring member 44 fixed to the slider 41 for locking with a notch 95 formed on the memory card 9. The slider 41 is movably received in the sliding groove 141. The coil spring 43 is assembled between the slider 41 and the insulative housing 1 and gives the slider 41 elastic force to realize ejecting the memory card 9 from the card connector 100. The connecting rod 42 has a front end retained in the slider 41 and a rear end movably received in the heart-shaped cam groove 142. The card connector 100 is so-called push-push type card connector and the working theory of the card ejecting mechanism 4 is well known to those of ordinary skill in the art, so the detailed description is omitted hereinafter.

The switch contacts 3 include first and second contacts 31, 32 retained in the first and second grooves 131, 132 respectively. The first contact 31 and the second contact 32 can be selectively on/off that is determined by the insertion position of the memory card 9.

The metal shell 5 includes a top wall 51 covering the receiving space 11, and a pair of side walls 52 extending downwardly from two lateral sides of the top wall 51 and retained in the left and right walls 13, 14 of the insulative housing 1.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. A card connector for insertion of a memory card comprising:
an insulative housing defining a receiving space for insertion of the memory card and a bottom wall located under the receiving space, the bottom wall having a recess recessed downwardly from an upper face thereof and located in a front region thereof, and a recessed wall located under the recess and defining an upper face located lower than the upper face of the bottom wall;
a plurality of terminals insert molded into the insulative housing and comprising retaining portions retained in the recessed wall, contacting portions protruding upwardly into the receiving space from the retaining portions for mating with the memory card, and tail portions extending out of the insulative housing for being mounted onto a printed circuit board, the retaining portions having upper faces exposed to the recess and coplanar with the upper face of the recessed wall; and
a metal shell attached to and covering the insulative housing.

2. The card connector according to claim 1, wherein the terminals comprise embedded portions extending forwardly from the corresponding retaining portions and wholly embedded in the recessed wall.

3. The card connector according to claim 2, wherein the embedded portion has a thickness in a height direction thinner than that of the retaining portions.

4. The card connector according to claim 3, wherein the embedded potions have lower faces coplanar with lower faces of the retaining portions and upper faces located lower than the upper faces of the retaining portions.

5. The card connector according to claim 1, wherein the bottom wall has a slot passing therethrough in a height direction of the bottom wall and forms a beam portion located between the recess and the slot, the retaining portions have front parts retained in the recessed wall and rear parts embedded in the beam portion.

6. The card connector according to claim 5, wherein the terminals further comprise connecting portions connecting the tail portions and the retaining portions, the connecting portion and the contacting portion are formed as two branches both extending from the corresponding rear part of the retaining portion.

7. The card connector according to claim 6, wherein the connecting portion has a first part connecting with the rear part and exposed to the slot, and a second part connecting with the tail portion and embedded in the bottom wall.

8. The card connector according to claim 7, wherein the bottom wall has a plurality of circle holes formed between each two adjacent front parts and a plurality of cutting holes formed between each two adjacent second parts.

9. A card connector for insertion of a memory card comprising:
an insulative housing defining a receiving space for insertion of the memory card and a bottom wall located under the receiving space; and
a plurality of terminals insert molded into the insulative housing and comprising retaining portions retained in the bottom wall and having upper faces exposed out, contacting portions protruding backwardly and upwardly into the receiving space from back ends of the retaining portions for mating with the memory card, and tail portions extending outwardly from the insulative housing for being mounted onto a printed circuit board;
wherein the terminals further comprise embedded portions extending forwardly from front ends of the corresponding retaining portions and wholly embedded in the bottom wall.

10. The card connector according to claim 9, wherein the bottom wall has a recess recessed downwardly from an upper face thereof and extending forwardly through a front edge thereof for receiving a label positioned on the memory card, and a recessed wall located under the recess for retaining the retaining portions and defining an upper face located lower than the upper face of the bottom wall, the upper faces of the retaining portions are exposed to the recess.

11. The card connector according to claim 10, wherein the upper faces of the retaining portions are located lower than the upper face of the bottom wall.

12. The card connector according to claim 10, wherein the upper faces of the retaining portions are coplanar with the upper face of the recessed wall.

13. The card connector according to claim 9, wherein the embedded portions have thicknesses in a height direction thinner than that of the retaining portions.

14. The card connector according to claim 13, wherein the embedded potions have lower faces coplanar with lower faces of the retaining portions and upper faces located lower than the upper faces of the retaining portions.

15. The card connector according to claim 9, wherein the terminals further comprise connecting portions connecting the tail portions and the retaining portions, the connecting portion and the contacting portion are formed as two branches extending from the corresponding rear part of the retaining portion.

16. A card connector comprising:
an insulative housing defining a bottom wall with a card receiving space above said bottom wall;
a plurality of terminals embedded within bottom wall via an insert molding processs, and side by side arranged with one another in transverse direction, each of said terminals defining an elongated base portion along a longitudinal direction perpendicular to said transverse direction, said base portion having a solder tails, at a first end thereof, exposed outside of the housing for soldering to a printed circuit board, and a resilient contacting section linked to a second end of the elongated base portion, which is opposite to said first end, and extending toward said first end with contacting points extending into the card receiving space;
a joint section between the base portion and the corresponding resilient contacting section being essentially exposed upon an upper face of a front region of the bottom wall;
a transverse bar being formed on the bottom wall and extending in said transverse direction to cover the terminals behind said joint sections of the terminals for efficiently retaining the terminals in position; and
a plurality of through holes formed in the bottom wall and alternate arranged with the joint sections in said transverse direction for separating linking between the joint sections of the neighboring terminals during said insert molding process.

17. The card connector as claimed in claim 16, wherein almost all upper surfaces of the joint sections are flush with the upper face of the front region of the bottom wall.

18. The card connector as claimed in claim 17, wherein a tip of the joint section is thinned to be hidden under the upper face of the front region of the bottom wall for protection consideration.
